(19) United States
(12) Patent Application Publication
(10) Pub. No.: US 2002/0049683 A1
(43) Pub. Date: Apr. 25, 2002

(54) Process for preventing frauds with regard to a taxi equipped with an electronic taximeter

(75) Inventor: Claude Ricard, Glencoe, IL (US)

Correspondence Address: BROWDY and NEIMARK, Suite 300, 624 Ninth Street N.W., Washington, DC, 20001-5303, US

(73) Assignee: GLEIKE INC., Glencoe, IL

(21) Appl. No.: 09/982,797

(22) Filed: Oct. 22, 2001

(30) Foreign Application Priority Data
Oct. 20, 2000 (FR) 00 13439
Nov. 13, 2000 (FR) 00 14549

(51) Int. Cl. G06F 17/00

(52) U.S. Cl. 705/417

(57) ABSTRACT

Process for preventing frauds with regard to a taxi equipped with an electronic taximeter (1) possessing a “for hire” position and a tariff position, which is associated with a printer whose job is to print, at the end of each trip, a receipt intended to be given to the customer, said printer having at least its printing head (20) mechanically separate from the taximeter (1), but being electrically connected to it, which consists in detecting the occurrence of a disconnection of the printing head (20) of the printer with respect to the taximeter (1), and as the case may be:

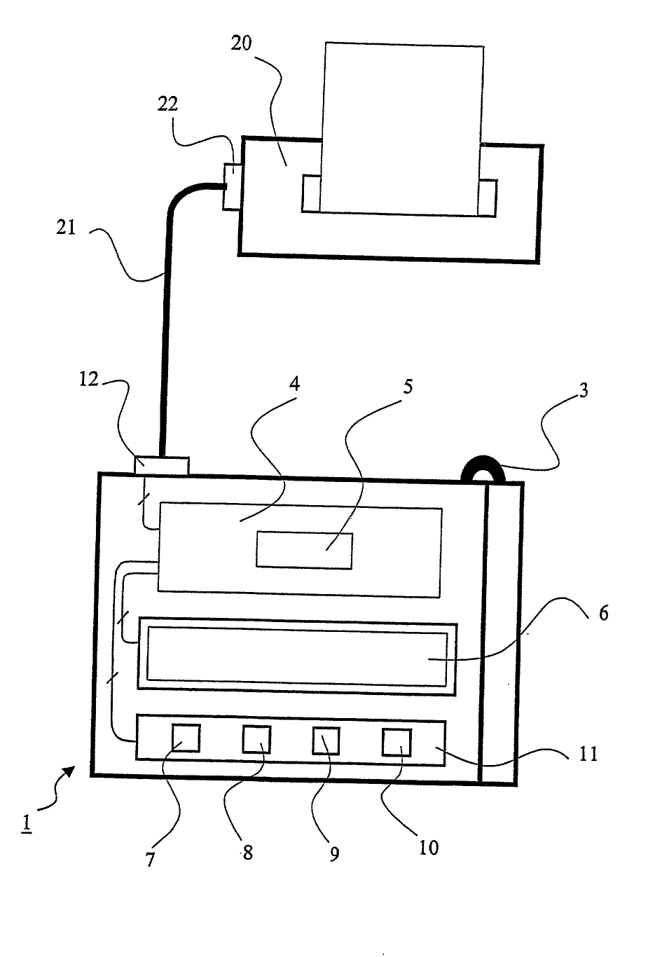

if the disconnection occurred while the taximeter is in the “for hire” position, in prohibiting the subsequent switching of the taximeter into the tariff position, for as long as this disconnection endures;

if the disconnection occurred while the taximeter is in the tariff position, in triggering an antifraud action.

### TECHNICAL FIELD

The invention pertains to the field of taximeters. It is more particularly aimed at a process intended to prevent frauds with regard to electronic taximeters associated with a printer whose job is to print, at the end of each trip, a receipt intended to be given to the customer.

### PRIOR ART

Modern taximeters are electronic taximeters which operate under the control of a microprocessor which is integrated into the taximeter. At present, electronic taximeters are associated with a printer which outputs a ticket at the end of each trip, this ticket being intended for the customer so that he receives a detailed statement relating to the journey which he has just made by taxi.

Risks of fraud exist, if the taxi driver is tempted to have his customer pay a different amount from that calculated by the taximeter, and which appears on the receipt.

Current standardization therefore makes it compulsory for this receipt to be automatically output at the end of each trip, and even prescribes the disabling of the taximeter should the printer no longer be supplied with paper when a trip commences.

Thus, the document EP 0 880 111 has described an improved process checking that the quantity of paper still present on the printing roll is sufficient for the printing of the ticket for the forthcoming trip.

More precisely, this process checks the quantity of paper remaining when the taximeter switches from a “for hire” position, that is to say before the start of a trip, to a tariff position, during which the taximeter calculates the amount for the trip, as a function of time and of distance traveled. If this quantity is insufficient, this causes the disabling of the taximeter, that is to say the impossibility of switching from the “for hire” position to the tariff position.

Generally, a printer associated with a taximeter is not fully integrated into the interior of the taximeter itself, so as to facilitate maintenance operations. Specifically, the printing head constitutes one of the most fragile members of the printer, since it is at this point that the paper of the ticket is at risk of jamming. The printing head must therefore be easily accessible so as to allow the taxi driver to free the jammed paper, or quite simply to replace the empty paper roll.

However, it is known that taximeters comprise a box which is sealed, and whose opening is authorized only by the authorities in charge of the regulations for taximeters. This is why the printing head, which as has been seen constitutes a sensitive part of the printer, is not generally integrated into the interior of this box, but generally sited elsewhere, outside it.

More precisely, the printing head proper is then separate from the taximeter, and linked electrically by an electric cord. This cord provides for the electrical supply to the printing head, and the transmitting of the signals produced by the remainder of the printer, or the microcprocessor of the taximeter, so as to allow the printing of the various characters by the printing head.

Hence, the printing head can be easily replaced in the event of a breakdown, by simply disconnecting the appropriate cord.

However, it is appreciated that deliberate disconnection of the printing head prevents correct printing of the receipt at the end of the trip, and therefore constitutes a risk of fraud. This is the problem which the invention proposes to solve.

### DESCRIPTION OF THE INVENTION

The invention therefore relates to a process for preventing frauds with regard to a taxi equipped with an electronic taximeter. This electronic taximeter is associated with a printer whose job is to print, at the end of each trip, a receipt intended to be given to the customer. This printer comprises at least its printing head mechanically separate from the taximeter, but which is electrically connected to the latter.

In accordance with the invention, this process consists in detecting the occurrence of a disconnection of the printing head of the printer with respect to the taximeter, and as the case may be:

if the disconnection occurred while the taximeter is in the “for hire” position, in prohibiting the subsequent switching of the taximeter into the tariff position, for as long as this disconnection endures;

if the disconnection occurred while the taximeter is in the tariff position, in triggering an antifraud action.

In practice, in a first variant, the antifraud action can consist in neutralizing the taximeter, so that it is then necessary to break the tamperproof seal of the taximeter, and/or to call on the authorities in charge of the regulations for taximeters to reauthorize its operation.

In another variant, the antifraud action can consist in recording the disconnection in a journal file or a memory contained in the taximeter. This then involves for example a file of anomalies which is managed by the microprocessor of the taximeter. This journal may be erased only by the authorities and/or after having broken the tamperproof seal of the taximeter. Hence, the log of the disconnection is therefore preserved, thereby allowing the empowered authorities to take cognizance thereof during a check. Corresponding sanctions may then be taken up depending on the regulations.

The antifraud action may advantageously take place when the taximeter subsequently exits from the tariff position.

Stated otherwise, the process in accordance with the invention consists in managing the detection of the absence of the printer differently depending on whether it is before a trip, or during a trip. Thus, if the printer is unplugged while the taximeter is in the “for hire” position, that is to say the trip has not yet begun, then the switch to the tariff position will be authorized only if the printer is reconnected. While the printer remains unplugged, the switch to the tariff position will not be authorized, so that the trip cannot start under nonregulatory conditions.

Conversely, when the printer is unplugged although the trip has already started, and the taximeter is in the tariff position, the taximeter continues to operate normally, so that the amount calculated and displayed at the end of the trip does not experience the influence of this disconnection.

However, since there is every reason to believe that such a disconnection corresponds to a fraudulent act, it will produce an effect which may bring about sanctions on the part of the authorities in charge of regulations for taximeters. These sanctions may be almost immediate if the taximeter is neutralized, since the driver will be compelled to call on the empowered authorities to restore the normal operation of the taximeter. These sanctions may be postponed or potential, if the occurrence of the disconnection is saved in a memory or a journal file which cannot be erased other than by authorized personnel. This memory or this file may be examined by these personnel, for example during a periodic or spot check or else in the event of a complaint from a consumer.

Advantageously, in this case of writing to a memory or to a file the antifraud action will consist moreover of having an item of information appear on a ticket so as for example to effectively inform the checking services.

The neutralization may transpire for example when the taxi driver tries to switch the taximeter to the “for hire” position. The neutralization may also transpire as soon as the driver makes the taximeter display the amount for the trip, that is to say just after he has switched to the “amount to pay” or “fare” position. Preferably, the display of the amount for the trip will be maintained permanently. Advantageously, this permanent display of the amount will be replaced by an error message when the electrical supply to the taximeter is interrupted. It will then be necessary to call on authorized persons to open the seals of the boxes of the taximeters to reinitialize a microprocessor control circuit and reauthorize normal operation. The fraud will thus have been detected.

Advantageously, in practice, the detection of the disconnection of the printer printing head may take place at specific instants. Thus, to monitor the disconnections while the taximeter is in the for hire position, the detection may advantageously take place during the request to switch from the “for hire” position to the tariff position. In respect of monitoring while the taximeter is in the tariff position, the detection can take place during the request to print the ticket corresponding to the request to switch from the tariff position to the “amount to pay” position.

Stated otherwise, it is possible to monitor the proper connection of the printer permanently, but it is sufficient and preferable to do so at the critical moments, namely the request to switch in the “for hire” position to the tariff position, and during the request to print the ticket, that is to say the switch to the “amount to pay” position. Detection of the absence of a printer at this instant may for example bring about the recording thereof by the microprocessor in a journal file, or in a particular memory area, or else by way of a relay present on an electronic card of the taximeter.

Advantageously, in practice, the taximeter can signal the occurrence of a disconnection of the printing head of the printer. This signaling may take place if this detection occurs while the taximeter is in the “for hire” position, or if it is in the tariff position, or else in both cases.

Advantageously, in practice, this signaling can take place either by display on the dial of the taximeter, or else by the emission of a sound signal, of a light signal or more generally of an alarm signal.

In the case where the signaling is done on the display dial of the taximeter, it is advantageous not to bring about the erasure of the total for the trip. This signaling may for example be performed by a pictogram. It may also take place intermittently with the latter, according to a periodicity of the order of from one to a few seconds. In the case of a disconnection detected upon switching to the “fare” position, provision may also be made for the display of the amount to be frozen for a predetermined duration, typically of the order of a few minutes. The stillness of the display despite the driver's attempts to switch to the “for hire” position is visual evidence of an attempt at fraud and makes it possible to have the amount displayed while the driver and the customer complete the trip.

In practice, the detection of the disconnection of the printer or of its printing head may be carried out in various ways.

Thus, it is possible to monitor signals generated by the printing head, and dispatched to the remainder of the printer, or the microprocessor of the taximeter. These signals may be line return pulses, character synchronization signals which are generally exchanged between the printing head and the remainder of the printer or the control circuit for the printing head.

It is also possible to monitor signals which are emitted by an electronic module present in the printing head, in response to monitoring signals generated by the remainder of the printer or the taximeter.

Stated otherwise, the printing head may then be equipped with a specific electronic module intended to emit signals attesting the presence of the printing head and hence its proper connection, on request of the remainder of the printer or the microprocessor of the taximeter.

The monitoring of the presence of the printing head may also be carried out by monitoring the electrical consumption of the printing head. Should the printing head be absent, the electrical consumption, of which the image is the current absorbed by the printing head, becomes zero, or goes below a threshold.

The process in accordance with the invention can also be adapted so as to limit other risks of fraud. Thus, another fraudulent activity consists in removing the paper or in adding insufficient paper to the printer to print a receipt. To avoid the fraud consisting in removing the roll of paper, a paper presence detector can be incorporated into the printer and prohibits the driver from commencing a trip without paper. As described in the document EP 0 880 111, this detector may be improved so as to eliminate the risks of fraud consisting in adding sufficient paper to actuate the detector but insufficient to print a receipt.

The process in accordance with the invention can be adapted to detect not only the unplugging of the printer but also the absence or insufficiency of paper. Thus, advantageously, when the check of the paper supply detects an insufficient (or nonexistent) supply, the taximeter triggers an antifraud action. This check can advantageously be made during the request to print the ticket. In one specific form, the triggering of the antifraud action can transpire after a specified duration sufficient for the replacement of the paper roll. The driver is thus allowed the time to fit a new roll, when the previous one has effectively been completely consumed, without penalizing him unduly.

### BRIEF DESCRIPTION OF THE FIGURE

The manner in which the invention may be embodied, as well as the advantages which ensue therefrom will be clearly apparent from the description of the embodiment which follows given by way of nonlimiting example, in support of the single appended FIGURE, which is a simplified diagram of a taximeter associated with a printer printing head in accordance with the invention.

### MANNER OF EMBODYING THE INVENTION

The taximeter (1) illustrated in the single FIGURE consists of a sealed box (2), equipped with a seal (3) or with a similar device which has to be destroyed to open the box (2) and access the elements which it contains. Hence, the authorities in charge of the regulations for taximeters, who are the only ones empowered to open the box of taximeters, can verify that it has not been opened in an unauthorized manner.

Of course, the invention is not limited to a particular form of location of this seal as illustrated in the figure but on the contrary covers all variant embodiments.

Conventionally, the taximeter (1) is equipped with an electronic card (4) which includes a microprocessor (5) whose job is to carry out the various taximeter calculation and control operations. This electronic card (4) is linked to a display (6) enabling the driver and the customer to ascertain various items of information relating to the operation of the taximeter, such as the type of tariff used and the running total for the trip for example. Of course, other information may also be displayed.

The electronic card (4) of the microprocessor is also linked to a set of buttons (7-10) or a keypad allowing the input of information by the driver. The number of items of information and their type may be extremely variable depending on the regulations of the country in which the taximeter is used. Among these buttons, one or more are in particular intended for changing the mode of operation of the taximeter.

Thus, in a known manner, a taximeter can operate according to various modes. A first mode corresponds to the situation in which the taxi is for hire, and is ready to receive a customer so as to begin a trip. This mode is generally called the “for hire” position in English-speaking countries (or “libre” in France). The taximeter is in this position when the customer enters the taxi.

The taximeter can operate according to other modes during which it meters the time and the distance traveled. These modes are generally called the “tariff” positions. These positions may be multifold, depending on whether the regulations allow the application of various tariffs, for example tariffs dependent on the time of day or on the distance of the trip. These tariff positions correspond to a so-called “occupied” state of the taxi. In English-speaking countries, this state is generally called “hired”. When the taxi driver picks up the customer, and the trip begins, he actuates the appropriate button of the keypad (11) so as to switch the taximeter to the tariff position.

Conversely, when the trip is finished, the driver presses a button (8) generally called “amount to pay” or “fare”. In English-speaking countries, this state is generally called “time off”. This button halts the metering of the amount for the trip on the basis of time and brings about the displaying of the amount to pay. It also triggers the printing of the ticket. Then, when the total has been paid, he actuates the appropriate button so as to switch the taximeter back to the “for hire” position.

In accordance with a characteristic of the invention, the taximeter is associated with a printer allowing the printing of the receipt. More precisely, in the form illustrated, the printing head (20) of the printer is mechanically separate from the taximeter (1) proper, so as to ease for example the maintenance and replacement operations.

This printing head (20) is linked to the taximeter (1) by a cord (21) and one or two connectors (12, 22). The engaging of the connectors (12, 22) is latched mechanically by a latch, appropriate lugs, a cap or any other equivalent system which prevents untoward disconnection. Hence, disconnection can be deliberate only. In the form illustrated, the management of the printing functions is carried out directly by the single electronic card (4) of the taximeter (1), this making it possible to reduce the cost of the assembly. Nevertheless, the invention also covers the variants in which the whole of the printer is sited elsewhere, provided that the principle of the invention is complied with, that is to say that there is a detachable link between the printing member and the sealed taximeter. Such is the situation for a taximeter possessing a first main electronic card, and a second electronic card specific to the printing functions controlling a printing head sited elsewhere.

During normal operation, the printing head (20) is powered electrically by the taximeter (1) via the cord (21). The various control signals for the members of the printing head are also dispatched by the electronic card (4) to the printing head (20). Conventionally, signals corresponding to the state of the printing head (20) are sent back to the electronic card (4) by the printing head (20). This may for example be the line return information, signifying that the paper has been advanced by one line, or else synchronization signals for the characters conventionally generated by a printing head. Thus, the detection of the presence of the printer may be effected by monitoring the proper return of information of this type.

The detection of the presence of the printer may also take place through the monitoring of the supply current to the printing head (20). This supply current can for example be measured by measuring the voltage present across the terminals of a resistor placed in series with the supply circuit for the printing head (20), or more generally an ampere-metering circuit.

In a different form of execution (not illustrated), the printing head may comprise a specific electronic module, able to emit particular signals toward the electronic card of the taximeter. The detection of these signals received by the electronic card then signifies that the printing head is actually connected to the taximeter. In the converse case, if such signals are not received, this signifies that the printer has been disconnected.

This specific electronic module mounted in the printing head can also generate signals in response to certain signals which might be emitted for this purpose by the electronic card of the taximeter.

Other variants may be envisaged, and are covered by the present invention, provided that they make it possible to detect the presence and the absence of the printing head.

In accordance with the invention, the taximeter manages the detection of the absence of the printer differently depending on the mode of operation of the taximeter, that is to say the fact that it is in the “for hire” position or in the tariff position.

Thus, if the driver has disconnected the printer before picking up a new customer, that is to say when the taximeter is in the “for hire” position, he will then attempt to switch to the tariff position so as to start the trip. In this case, he will press the appropriate button (7) of the keypad (11). At this moment, the microprocessor (5) which receives this request instigates a test for the presence of the printing head of the printer according to one of the modes described hereinabove. If it turns out that the printing head is absent, it will prohibit the switch to the tariff position, so that the trip cannot begin. Although not compulsory, but essentially ergonomic, the microprocessor will be able to display on the dial (6) a message indicating the absence of printer or a pictogram.

For as long as the printer is not reconnected, the subsequent attempts to switch to the tariff position will remain fruitless. If the driver reconnects the printer, the next attempt will then be accepted by the microprocessor, and the trip can begin normally.

The invention is not limited solely to this mode of operation in which the detection of the presence of the printing head is performed only during requests to switch to the tariff position, but the microprocessor (5) can also perform a detection periodically, independently of the moments at which the driver actuates the mode change buttons (7-10).

Furthermore, when the trip has begun, and the driver has disconnected the printer during the trip, the manner of operation is different. Specifically, the taximeter (1) can then switch directly to “neutralization mode” as described in the following paragraph or else continue to operate normally so that the trip is concluded in such a way that the sum total is of course displayed on the dial (6). At the moment when the driver presses the button (8) instructing the switch to the “amount to pay” position and hence the printing of the ticket, although he is perfectly well aware that printing will not be possible since he has previously unplugged the printer, the microprocessor (5) instigates a test to detect the presence of the printing head. If this test indicates the absence of the printer, the microprocessor (5) stores the information item. After the driver has informed his customer that printing did not work properly and that he cannot therefore provide a receipt, he presses the appropriate button so as to switch the taximeter to the “for hire” position.

In this case, the microprocessor (5) makes the taximeter switch to a particular mode, the so-called “neutralization mode”. In this mode, no further operation is possible under the action of the keypad, and it is not therefore possible to make trips in the normal way.

Stated otherwise, if the driver wishes to fall in line with the regulations, he will have to request the intervention of the authorities empowered to open the boxes of the taximeter, so as to reinitialize the microprocessor (5). Of course, this intervention entails administrative formalities, and possible sanctions which are such as to deter the driver from effecting disconnections of the printing head.

The invention also covers the variants in which the neutralization transpires as soon as the driver requests the switch to the “amount to pay” position, although after the taximeter has displayed the sum total of the amount for the trip. In this case, it is preferable for the sum total for the trip to remain displayed for long enough, for example a few minutes, on the one hand for the customer to be able to see and acknowledge the amount for the trip, and on the other hand for the next customer to notice abnormal operation, since the driver will be unable to switch the taximeter to the “for hire” position. According to an advantageous embodiment, after a few minutes, an error message will be displayed so as to prevent any use of the taximeter.

It is also possible to carry out detection of the presence of the printing head independently of the actions of the driver on the keypad. Thus, periodic detection of the presence of the printer may be carried out by the microprocessor (5). If this test reveals that the printer is absent while the taximeter is in the tariff position, the information can then be stored in memory, and bring about automatic neutralization of the taximeter during a subsequent request to switch to the “for hire” position, or to switch to the “amount to pay” position.

As described earlier, the disconnection of the printer while the taximeter is in the tariff position may bring about the display on the frame of the taximeter of a corresponding message, possibly intermittently with the display of the running total for the trip.

The signaling of the absence of the printer may also take place, as already mentioned, through a sound or light signal, or any other kind of alarm signal.

As mentioned hereinabove, the neutralization is not the only antifraud action provided for in the process in accordance with the invention. Thus, it may be replaced by the saving of the occurrence of the disconnection in a journal file or in a memory provided for this purpose. The erasure of this information is possible only by accessing the interior of the taximeter by breaking the tamperproof seal or else via a system involving an electronic key held by authorized persons, in particular the authorities in charge of monitoring taximeters. This key may be a simple password communicated to the microprocessor by means for example of the keypad (11) or a device which is recognized by the microprocessor or any other known means for carrying out identification. For example in taximeters equipped with a magnetic card reader the key can be a card with particular contents. Thus, a check performed by authorized persons shows up the attempted fraud and may bring about sanctions.

Advantageously, the authorities in charge of monitoring taximeters who will have to be called on in the event of a neutralization of the taximeter will use, to terminate the neutralization, the same means as those described in the previous paragraph for erasing the journal file or the memory.

It emerges from the foregoing that the process in accordance with the invention makes it possible to limit the risks of frauds by disconnection of the printing head. It nevertheless authorizes the replacement of the printing head when the taximeter is in the “for hire” position, which constitutes an operation not constituting fraud, provided that it is completed before switching to the tariff position.

On the other hand, for its part, the disconnection of the printing head during a trip, which is an abnormal and generally fraudulent act, brings about either the neutralization of the taximeter directly, or the recording of the attempted fraud and hence potential sanctions.

1. A Process for preventing frauds with regard to a taxi equipped with an electronic taximeter (1) possessing a “for hire”, position and a tariff position, which is associated with a printer whose job is to print, at the end of each trip, a receipt intended to be given to the customer, said printer having at least its printing head (20) mechanically separate from the taximeter (1), but being electrically connected to it, which consists in detecting the occurrence of a disconnection of the printing head (20) of the printer with respect to the taximeter (1), and as the case may be:
if the disconnection occurred while the taximeter is in the “for hire” position, in prohibiting the subsequent switching of the taximeter into the tariff position, for as long as this disconnection endures;
if the disconnection occurred while the taximeter is in the tariff position, in triggering an antifraud action.

2. The process as claimed in claim 1, wherein the antifraud action consists in neutralizing the taximeter, so that it is then necessary to break a seal and/or to call on the authorities in charge of monitoring taximeters to reauthorize the operation of the neutralized taximeter.

3. The process as claimed in claim 1, wherein the antifraud action consists in saving the occurrence of the disconnection in a journal file or a memory contained in the taximeter, and wherein it is not possible to erase without breaking a seal and/or calling on the authorities in charge of monitoring taximeters.

4. The process as claimed in claim 1 or 3, wherein the antifraud action consists moreover in making an item of information appear on a ticket.

5. The process as claimed in claim 1, wherein the neutralization of the taximeter transpires when the latter subsequently exits from the tariff position.

6. The process as claimed in claim 1, wherein the detection of a disconnection of the printing head (20) of the printer takes place at least during the request to switch from the “for hire” position to the tariff position.

7. The process as claimed in claim 1, wherein the detection of a disconnection of the printing head (20) of the printer takes place at least during the request to print the receipt.

8. The process as claimed in claim 1, wherein if the disconnection occurs while the taximeter is in the “for hire” position, the latter is signaled by the taximeter.

9. The process as claimed in claim 1, wherein if the disconnection occurs while the taximeter is in the tariff position, the latter is signaled by the taximeter.

10. The process as claimed in claim 8 or 9, wherein the signaling takes place by display on the dial (6) of the taximeter, or the emission of an alarm signal.

11. The process as claimed in claims 9 and 10, wherein the signaling of the disconnection takes place alternately with the displaying of the total for the trip.

12. The process as claimed in claim 1, wherein the disconnection of the printing head of the printer is detected by the monitoring of signals dispatched by the printing head (20) destined for the remainder of the printer or the taximeter.

13. The process as claimed in claim 12, wherein the signals monitored are line return pulses or character synchronization pulses.

14. The process as claimed in claim 12, wherein the signals monitored are signals emitted by an electronic module present in the printing head, in response to monitoring signals generated by the remainder of the printer or the taximeter.

15. The process as claimed in claim 1, wherein the disconnection of the printer is detected by monitoring the electrical consumption of the printing head.

16. The process as claimed in claim 1, wherein mechanically secure connectors which cannot be unplugged other than deliberately are employed for the connector or connectors for plugging in the printing head.

17. The process as claimed in claim 1, wherein it consists moreover in checking the paper supply to the printing head, and in triggering the antifraud action in the case where this supply is insufficient to allow correct printing of the receipt.

18. The process as claimed in claim 17, wherein the checking of the paper supply is performed during the request to print the receipt.

19. The process as claimed in claim 17, wherein the checking of the paper supply makes it possible to detect the absence of the roll of paper associated with the printing head.

20. The process as claimed in claim 19, wherein the checking of the paper supply makes it possible to detect that the length of paper present on the roll is sufficient to allow the complete printing of the receipt.

21. The process as claimed in claim 19, wherein the triggering of the antifraud action takes place after the checking, following the elapsing of a predetermined duration sufficient for the replacement of the paper roll.
